(19) United States
(12) Patent Application Publication
(10) Pub. No.: US 2024/0262074 A1
(43) Pub. Date: Aug. 8, 2024

(54) BURN THROUGH RESISTANT BARRIER COMPOSITE

(71) Applicant: AvenEx Coating Technologies Kft., Gesztenyefa (HU)

(72) Inventors: Manish SETH, Burnaby (CA); Gregory K. JONES, Mechanicsville, VA (US)

(21) Appl. No.: 18/428,608

(22) Filed: Jan. 31, 2024

Related U.S. Application Data
(60) Provisional application No. 63/443,228, filed on Feb. 3, 2023.

(51) Int. Cl. B32B 5/02; B32B 27/12; E04B 1/94

(52) U.S. Cl. CPC B32B 5/024; B32B 27/12; E04B 1/941; B32B 2262/0253; B32B 2262/103; B32B 2262/128; B32B 2307/3065; B32B 2307/7246; B32B 2307/7265; B32B 2307/7376; B32B 2419/06

(57) ABSTRACT

A burn resistant barrier composite for application to a roof or wall of a building incorporates a metal foil in a woven fabric to improve burn through resistance. The barrier composite may be a roof underlayment or a housewrap. A barrier composite incorporates a polymer film attached to a metal foil that is cut into tapes and then woven into a woven fabric. The polymer film may be a tensilized polymer film that has increase modulus through orienting the film. The space between the tapes in the woven fabric provides permeability for moisture vapor. An additional barrier layer may be attached to the woven fabric to prevent moisture and/or water transfer through the barrier composite or to enable moisture vapor transmission through the barrier composite. An adhesive may be attached to the barrier composite to enable direct adhesion to a wall or roof surface.

### CROSS REFERENCE TO RELATED APPLICATIONS

This application claims the benefit of priority to U.S. provisional patent application No. 63/443,228, filed on Feb. 3, 2023.

### BACKGROUND OF THE INVENTION

### Field of the Invention

The invention relates to barrier composites with a foil layer to improve burn through resistance, wherein the barrier composites are configured for application to an exterior of a building to provide a barrier from precipitation and allow precipitation to drain down along the barrier layer and away from the building and may include a moisture vapor transmission layer to allow moisture vapor to pass through the barrier composite to prevent mold.

### Background

Roofing underlayment is used to provide a layer of additional resistance for moisture to pass through the roof into the building and may be non-breathable synthetic material. The roofing underlayment is applied over the plywood and shingles are mechanically attached to the roof, such as by roofing nails through the shingle, through the roofing underlayment and into the plywood. Shingles and roofing underlayment do not provide much resistance to preventing embers catching the building on fire. The embers can burn through the shingles and underlayment and then catch the plywood on fire.

Housewrap is used to prevent precipitation from contacting the exterior wall board or surface of a building or home. The housewrap has a barrier layer that is water resistance to prevent water from passing therethrough. Housewrap also insulates the building by preventing bulk flow of air through the seams in the exterior wall board. A housewrap material is placed between the exterior wall board, such as plywood, and the outer shingles or siding of the home. Housewrap may include an adhesive that enables a sheet of the housewrap to be adhered directly to the exterior wall board. The adhesive is typically covered with a detachable release film that is removed before application to a wall or roof.

Wildfires are growing more frequent and more severe especially in the southwest and pacific coast of the United States. Standard housewrap provides little resistance to fire.

### SUMMARY OF THE INVENTION

The invention is directed to barrier composites that incorporate a metal foil in a woven fabric to improve burn through resistance. The barrier composite may be configured as a roof underlayment and may increase the resistance to fires. The barrier composite may be configured as a housewrap that also improves burn through resistance while having effective moisture vapor transmission through the barrier composite. An exemplary barrier composite incorporates a polymer film attached to a metal foil that is configured as tapes that are woven into a woven fabric. The polymer film may be a tensilized polymer film that has increase modulus through orienting or stretching the film below the melt temperature. The space between the tapes in the woven fabric provides permeability for moisture vapor. An additional barrier layer of material may be attached to the woven fabric to prevent moisture and/or water transfer through the barrier composite or to enable moisture vapor transmission through the barrier composite. A solid impermeable layer or permeable layer may be attached to the barrier composite for roof underlayment and a moisture vapor transmission layer may be attached to the woven fabric for housewrap applications. An adhesive may be attached to the barrier composite to enable direct adhesion to a wall or roof surface.

An exemplary burn resistant barrier composite may be made by first attaching a metal foil to a polymer film to form a composite layer that may then be slit to form composite tapes. Again, the polymer film may first be tensilized, or oriented by being stretched to improve mechanical properties, in particular modulus. The polymer film may be heated to a temperature just below the melt temperature during the stretching of the polymer film to orient and tensilized the polymer film. A tensilized polymer film may have a modulus that is about 20% greater or more than a non-tensilized or simply extruded polymer film of the same type, or about 50% greater or more, or about double, or about five times greater or more. The composite tapes may have a width of about 10 mm or less, about 6 mm or less, about 4 mm or less, about 2 mm or less, or even about 1 mm or less. The narrower tapes may be easier to weave into a composite woven fabric. The tapes are then woven into a woven fabric and the metal foil may be configured on the same side of the woven fabric from tape to tape in the weave. The type of weave may be a plain or basket weave, a twill weave, a satin weave, a leno weave or other type of weave that provides effective strength. The weave may be chosen to provide a particular amount of intersections that may enable vapor transmission through the barrier composite. An additional barrier layer of material may be coupled to the woven fabric to prevent water transfer or to prevent liquid water transfer through the barrier composite while allowing moisture vapor transmission.

The metal foil that may be used in the barrier composite may be aluminum, steel, an alloy or any other suitable type of metal foil. The cost is an important factor as a large amount of material is required for both the roof underlayment and housewrap applications. The metal foil may have a thickness of about 25 μm or less, about 20 μm or less, about 15 μm or less, about 10 μm or less, about 5 μm or less and any range between and including the thickness values provided. A thicker metal foil may provide more burn through resistance while a thinner metal foil layer may be less expensive and may result in a lighter weight barrier composite.

The polymer film may be selected based on the application and location of use. An exemplary polymer film may be an olefin, polypropylene, polyethylene, polyester, polyurethane and the like. The polymer films maybe tensilized to increase the modulus. The polymer films may be uniaxially oriented or tensilized, wherein they are tensilized in one direction, the machine direction, or they may be biaxially oriented, wherein they are tensilized in both the machine direction and cross-machine direction.

The composite tapes may be narrow sheets of material, having a first surface that is planar and parallel with an opposing second surface, that is also planar. The composite tapes may have a thickness of about 10 mm or less, about 6 mm or less, about 4 mm or less, about 2 mm or less, or even about 1 mm or less. The composite tapes may have a width of about 10 mm or less, about 6 mm or less, about 4 mm or less, about 2 mm or less, or even about 1 mm or less.

The metal foil may be attached to the polymer film by lamination, such as melt lamination, wherein the polymer film is melted, or by the use of an adhesive or ultrasonic welding and the like. In melt lamination, a heated roller may be used and may only melt a very thin portion of the polymer film, thereby preserving the tensilized increased modulus of the polymer film. In an exemplary embodiment, the foil is bonded while maintaining the temperature below the melt temperature of the polymer film such that the oriented polymer film retains the increase modulus formed through tensilizing. The metal foil may have a foil adhesive that has a lower melting temperature than the polymer film and the foil adhesive may be heated above the melting temperature but below a melting temperature of the polymer film, such as through hot roll melt lamination. The foil adhesive may be a polymer, such as a thin polymer film or a pattern of adhesive, such as adhesive dots or netting, which may also be polymers. The difference in melting temperature of the foil adhesive layer to the polymer film may be about 10° C. or more, about 20° C. or more, about 40° C. or more, about 50° C. or more and any range between and including the temperature differentials provided. A higher temperature differential will make processing and attachment of the foil to the polymer film easier to control.

A barrier layer maybe attached to the barrier composite, such as to the polymer film or to the woven fabric. A barrier layer may be another layer of polymer film that forms a solid impermeable layer to prevent liquid water passage through the barrier composite. The barrier layer may be olefin, polypropylene, polyethylene, polyester, polyurethane and the like. In housewrap applications, the barrier layer may be a solid layer to prevent liquid water passage but may have a high moisture vapor transmission rate to enable moisture in the house to pass through the housewrap to prevent mold. An exemplary moisture vapor transmission barrier layer may include urethane, copolyester elastomer, microporous PP or PE, ethyl/ethylacrylate copolymer, ethyl/methylacrylate copolymer, and the like.

The moisture vapor transmission rate (MVTR) through the barrier composite, according to ASTM E96-00 may be about 2.0 perm or more, about 3.0 perm or more, about 4.0 perm or more, and even at least 5.0 perm or more. A moisture vapor layer may be gas impermeable layer having a Gurley Densometer time of more than 100 seconds, thereby preventing bulk flow of gas therethrough; as measured with a Gurley Model 4340 Automatic Densometer & Smoothness Tester, Gurley Precision Instruments, Troy, NY. The moisture vapor layer may be a solid layer of polymer, such as a layer of urethane or silicone.

An adhesive layer may be coupled to the barrier composite, such as to the barrier layer to enable direct attachment to the exterior surface of a building, such as the roof or walls. An adhesive layer may be a pressure sensitive adhesive that is configured in a continuous layer or as a discontinuous layer, such as dots or a grid or adhesive. A release liner may be configured over the adhesive layer to prevent adhesion of adjacent layers when in a roll form.

A barrier composite may include a woven fabric having a composite weave, wherein some of the tapes have the metal foil and others tapes do not include the metal foil. The composite weave may be configured with the metal foil containing tapes being in the warp or fill directions with the non-foil tapes in the opposing direction. Alternatively, just some of the tapes in either orientation, warp or fill, may be configured with or without the metal foil. A woven fabric that is a composite weave may be configured for improved traction for a roof underlayment to increase traction and coefficient of friction, as workers may need to walk across this woven fabric on a roof.

### Definitions

Shingles as used herein refers to the outer covering of a building or structure and may include shingles, siding and the like.

An integral release material that enables an adhesive, such as a pressure sensitive adhesive to peel away therefrom, whereby the integral release material fractures and sticks to the adhesive, for example.

An integral release layer includes portions of the surface area that are configured to fracture and stick to the adhesive when it is peeled away from or separated from the exterior surface of a barrier composite.

A barrier composite with stand-offs to promote drainage down along the barrier composite when applied to an exterior wall surface is referred herein as a drainage barrier composite, both of which are sheets or rolls of material that are flexible and capable of being spooled into roll.

Moisture vapor transmission rate through the barrier composite may be measured using ASTM E96-00 (Last Updated: Aug. 16, 2017), Water Vapor Transmission. ASTM E96 tests and evaluates the water vapor transfer through semi-permeable and permeable samples.

The summary of the invention is provided as a general introduction to some of the embodiments of the invention, and is not intended to be limiting. Additional example embodiments including variations and alternative configurations of the invention are provided herein.

### BRIEF DESCRIPTION OF SEVERAL VIEWS OF THE DRAWINGS

The accompanying drawings are included to provide a further understanding of the invention and are incorporated in and constitute a part of this specification, illustrate embodiments of the invention, and together with the description serve to explain the principles of the invention.

FIG. 1 shows a side cross sectional view of a building having a barrier composite, a burn resistant barrier composite, coupled to an exterior wall surface and shingles coupled to the exterior wall surface.

FIG. 2 shows a cross sectional view of a composite tape that is a composite film of a metal foil coupled to a polymer film.

FIG. 3 shows a cross sectional view of a woven fabric of the composite tape shown in FIG. 2 woven to form weave openings for permeability through the woven fabric.

FIG. 4 show a diagram of steps to produce a burn resistant barrier composite.

FIG. 5 shows a cross sectional view of an exemplary burn resistant barrier composite that includes a woven fabric of composite tapes made from a foil coupled to a polymer film, a barrier layer, an adhesive layer on an interior surface and stand-offs on an exterior surface.

FIG. 6 shows a cross sectional view of two layers of burn resistant barrier composite.

Corresponding reference characters indicate corresponding parts throughout the several views of the figures. The figures represent an illustration of some of the embodiments of the present invention and are not to be construed as limiting the scope of the invention in any manner. Some of the figures may not show all of the features and components of the invention for ease of illustration, but it is to be understood that where possible, features and components from one figure may be included in the other figures. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

### DETAILED DESCRIPTION OF THE ILLUSTRATED EMBODIMENTS

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations, modifications, improvements are within the scope of the present invention.

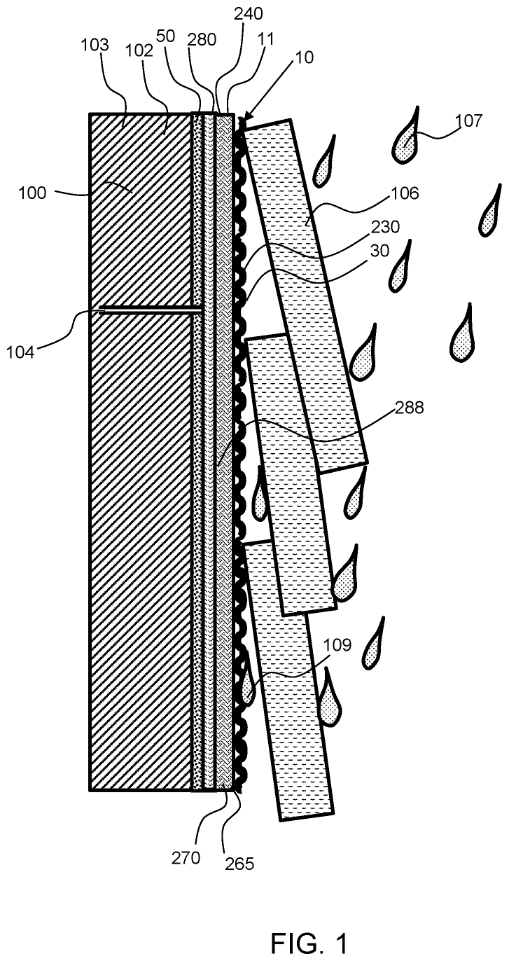

As shown in FIG. 1, a building 100 has a barrier composite 10, that is a drainage barrier composite 11 which includes metal foil 240 to make the barrier composite 11, a burn resistant barrier composite 230, as described herein, coupled to an exterior wall surface 102 and shingles 106 coupled to the exterior wall surface through the barrier composite. The burn resistant barrier composite 230 includes a woven fabric 270 made from composite tapes 265 that are woven to form weave openings for permeability. The burn resistant barrier composite also has a barrier layer 280, which include moisture vapor layer 288 to prevent precipitation 107, or water transfer therethrough but allow moisture vapor to pass through to prevent mold formation. The moisture vapor layer may be an air impermeable layer such as a thin layer of urethane or silicone. The burn resistant barrier composite 230 also has an adhesive 50 that adheres the barrier composite to the exterior wall surface, and a plurality of stand-offs 30 that enables the penetrated precipitation to drain down and along the barrier composite. The stand-offs may be optional as the weave may provide sufficient drainage. The burn resistant barrier composite 230 may prevent water from penetrating into seams 104 between the exterior wall boards 103. As shown, some precipitation 107 does pass through the shingles as penetrated precipitation 109.

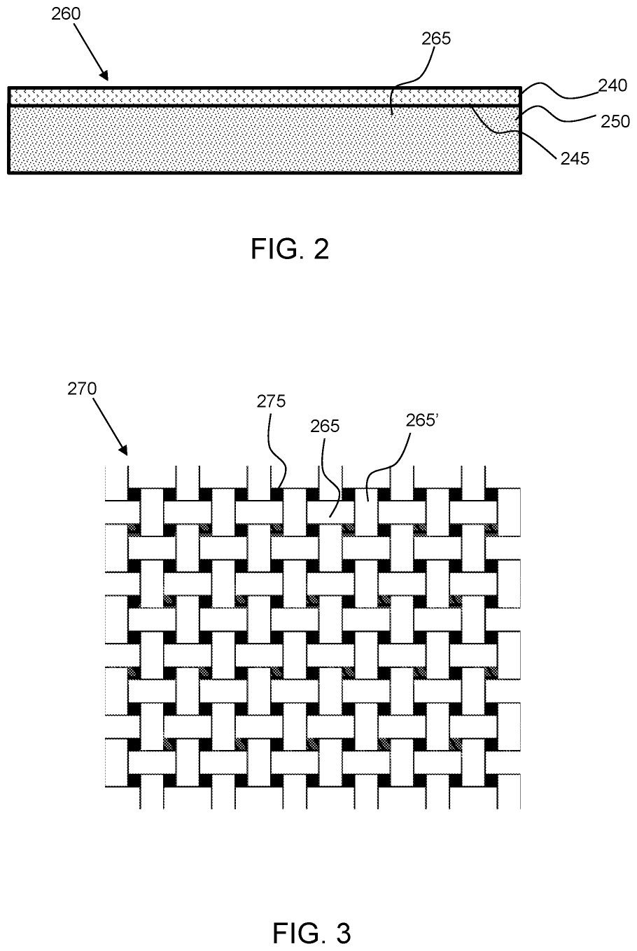

As shown in FIG. 2, a metal foil 240 is coupled to a polymer film 250, such as by thermal bonding or with a foil adhesive 245. The composite film 260 may be formed, such as by slitting into a composite tape 265. The composite film may include a polymer film that is a tensilized polymer film that has been heated and stretch to impart higher modulus and strength in the polymer film. The polymer film may be uniaxially oriented film or biaxially oriented film, tensilized or stretched in machine and cross machine directions.

As shown in FIG. 3, a woven fabric 270 in made from weaving the composite tape 265 shown in FIG. 2. The woven composite tapes 265, 265′ are configured in a basket weave with the tapes extending in orthogonal directions and forming weave openings 275 between the woven tapes for permeability through the woven fabric. The composite tape 265 may extend in a warp or machine direction or be a warp tape and composite tape 265′ may extend in a fill direction, or be a fill tape.

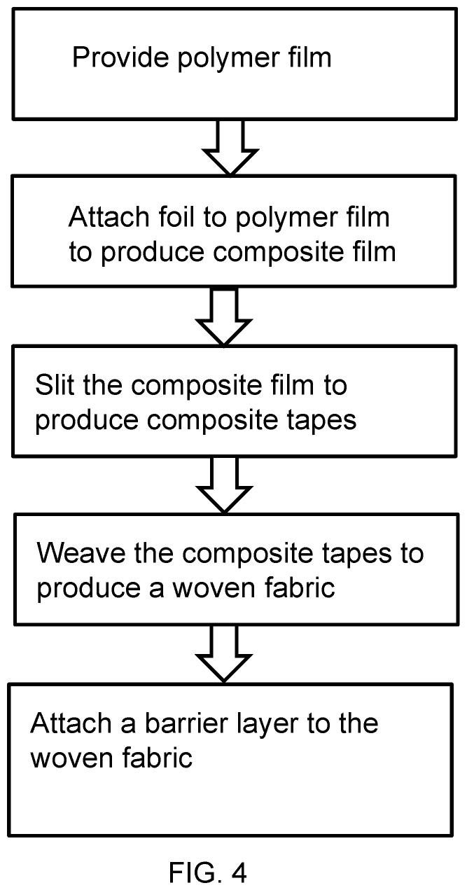

FIG. 4 show a diagram of steps to produce an exemplary burn resistant barrier composite. A polymer film is provided which may be a tensilized or oriented polymer film. A foil is attached to the polymer film, the film is slit to form composites tapes, The composite tapes are woven to produce a woven fabric having weave openings for permeability. A barrier layer may be attached to the woven fabric to prevent liquid water transfer through the woven fabric but allow moisture vapor to pass therethrough.

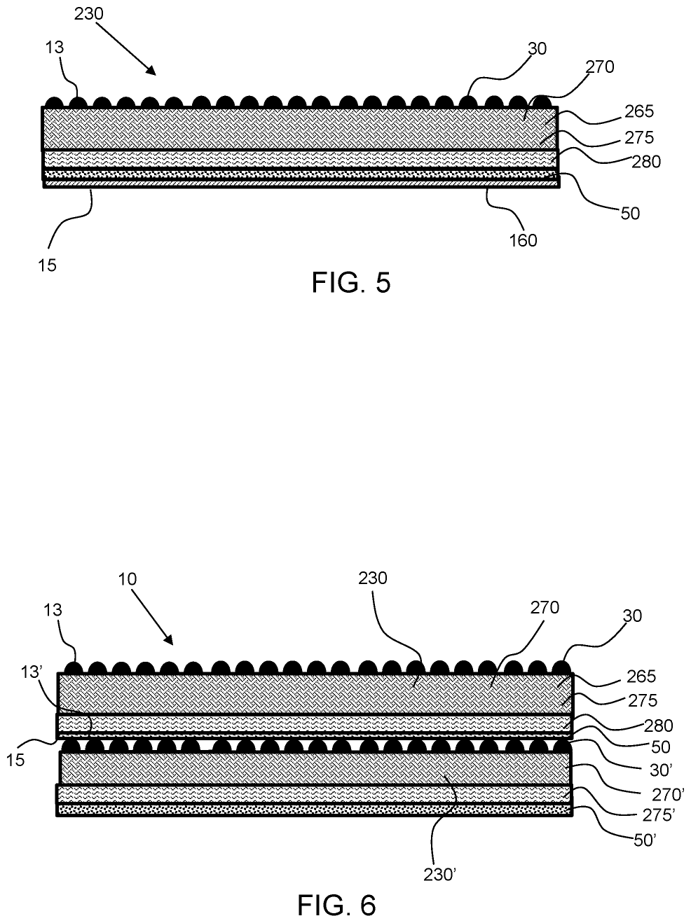

FIG. 5 shows a cross sectional view of an exemplary burn resistant barrier composite 230 that includes a woven fabric 270 of composite tapes 265 made from a metal foil coupled to a polymer film and woven to form weave opening 275, a barrier layer 280, an adhesive layer 50 on an interior surface 15 and stand-offs 30 on an exterior surface 13. Note that a release layer 160 may be configured over the adhesive 50 to prevent layers from bonding together when configured in a roll.

FIG. 6 shows a cross sectional view of two layers of burn resistant barrier composite 230, 230′ wherein the inside surface 15 of the first layer of burn resistant barrier composite 230 is against the exterior surface 13′ of the second layer of burn resistant 230′. The second layer of the burn resistant barrier composite has stand-offs 30′ that are against the inside surface 15 of the first layer. The second layer of the burn resistant barrier composite includes a burn resistant barrier composite 230, that is a woven fabric 270′ having weave openings 275′. The second layer of the burn resistant barrier composite 230′ also has an adhesive 50′.

It will be apparent to those skilled in the art that various modifications, combinations and variations can be made in the present invention without departing from the scope of the invention. Specific embodiments, features and elements described herein may be modified, and/or combined in any suitable manner. Thus, it is intended that the present invention cover the modifications, combinations and variations of this invention provided they come within the scope of the appended claims and their equivalents.

What is claimed is:

1. A burn resistant barrier composite comprising:
a) an exterior surface;
b) an interior surface configured for application to an exterior wall surface of a building;
c) a woven fabric of composite tapes,
wherein the composite tapes comprise:
a polymer film;
a metal foil attached to the polymer film;
d) a barrier layer that is water resistant, wherein liquid water will not pass through the barrier composite for 5 minutes with a 25 mm water column.

2. The burn resistant barrier composite of claim 1, further comprising an adhesive layer attached to the barrier layer and forming said interior surface of the barrier composite

3. The burn resistant barrier composite of claim 1, wherein the polymer film is an oriented polymer film.

4. The burn resistant barrier composite of claim 3, wherein the polymer film is a uniaxially oriented polymer film, oriented in a length direction of said composite tapes.

5. The burn resistant barrier composite of claim 3, wherein the polymer film is a biaxially oriented polymer film.

6. The burn resistant barrier composite of claim 3, wherein the polymer film is an olefin.

7. The burn resistant barrier composite of claim 3, wherein the polymer film one of polypropylene, polyethylene, olefin.

8. The burn resistant barrier composite of claim 1, wherein the metal foil is aluminum foil.

9. The burn resistant barrier composite of claim 1, wherein the metal foil has a thickness of no more than 25 μm.

10. The burn resistant barrier composite of claim 1, wherein the metal foil is configured on an exterior surface of the burn resistant barrier composite.

11. The burn resistant barrier composite of claim 1, wherein the barrier layer is a moisture vapor layer having a MVTR of at least 3 perm according to ASTM E96-00.

12. The burn resistant barrier composite of claim 1, wherein the moisture vapor layer is an air impermeable solid polymer layer.

13. The burn resistant barrier composite of claim 11, wherein the barrier layer is configured between the adhesive and the woven fabric.

14. The burn resistant barrier composite of claim 1, wherein the weave is a basket weave.

15. The burn resistant barrier composite of claim 1, wherein the weave is a twill weave.

16. The burn resistant barrier composite of claim 1, wherein the weave is a satin weave.

17. The burn resistant barrier composite of claim 1, wherein the weave is a leno weave.

18. The burn resistant barrier composite of claim 1, wherein the composite tape has a width of no more than 5 mm.

19. The burn resistant barrier composite of claim 1, further comprising stand-offs extending from an exterior surface of the barrier composite.

20. The burn resistant barrier composite of claim 1, wherein the polymer film is an olefin.
